(19) United States
(12) Patent Application Publication
(10) Pub. No.: US 2023/0135339 A1
(43) Pub. Date: May 4, 2023

(54) SANDWICH PANEL AND MANUFACTURING METHOD FOR SANDWICH PANEL

(71) Applicant: MITSUBISHI HEAVY INDUSTRIES, LTD., Tokyo (JP)

(72) Inventors: Kazuhiro MIURA, Tokyo (JP); Kentaro SHINDO, Tokyo (JP); Mikoto OMORI, Tokyo (JP)

(73) Assignee: MITSUBISHI HEAVY INDUSTRIES, LTD., Tokyo (JP)

(21) Appl. No.: 18/049,833

(22) Filed: Oct. 26, 2022

(30) Foreign Application Priority Data
Nov. 4, 2021 (JP) 2021-180363

(51) Int. Cl. B32B 21/14; B32B 3/30; B32B 38/10; B32B 37/18

(52) U.S. Cl. CPC B32B 21/14; B32B 3/30; B32B 38/10; B32B 37/182; B32B 5/02

(57) ABSTRACT

A sandwich panel includes: a core material having a plate shape; a pair of face plates that are formed using a composite material, and respectively disposed on both sides in a thickness direction of the core material; and a crack arrester that is formed using the composite material, disposed on at least one side in the thickness direction of the core material, disposed between the face plate and the core material, and disposed to project from the face plate toward the core material side. The crack arrester includes flat side surfaces being in contact with the core material and extending along the thickness direction from a boundary surface between the face plate and the crack arrester, and an angle formed by the side surface and the boundary surface is equal to or larger than 90 degrees.

### CROSS-REFERENCE TO RELATED APPLICATIONS

The present application claims priority to and incorporates by reference the entire contents of Japanese Patent Application No. 2021-180363 filed in Japan on Nov. 4, 2021.

### FIELD

The present disclosure relates to a sandwich panel and a manufacturing method for the sandwich panel.

### BACKGROUND

It has been known that there is a delamination development prevention structure of a sandwich panel for preventing development of delamination of the sandwich panel (for example, refer to Patent Literature 1). The delamination development prevention structure of the sandwich panel has a structure in which a delamination development prevention piece is disposed to project from a face plate of the sandwich panel toward an inner side in a thickness direction as a core material side. The delamination development prevention piece is formed on an unbent surface, and has a substantially semicircular cross-sectional shape, for example.

### CITATION LIST

### Patent Literature

Patent Literature 1: Japanese Patent Application Laid-open No. 2006-282046

### SUMMARY

### Technical Problem

Delamination of a sandwich panel occurs when external force caused by a vibration or an impact is applied to the sandwich panel. Herein, the external force includes a mode in which the external force is applied in an in-plane direction of a joint surface between the face plate and the core material (referred to as a lateral mode), and a mode in which the external force is applied in a thickness direction of the core material (referred to as a vertical mode). A conventional delamination development prevention piece is a composite material being in contact with the core material made of flexible foam material, so that development of delamination due to external force in the lateral mode can be prevented, but it is difficult to suppress occurrence and development of delamination due to external force with an impact in the vertical mode.

Thus, a problem of the present disclosure is to provide a sandwich panel and a manufacturing method for the sandwich panel that can preferably suppress delamination even in a case in which external force with an impact is applied in the thickness direction.

### Solution to Problem

A sandwich panel according to the present disclosure includes: a core material having a plate shape; a pair of face plates that are formed using a composite material, and respectively disposed on both sides in a thickness direction of the core material; and a crack arrester that is formed using the composite material, disposed on at least one side in the thickness direction of the core material, disposed between the face plate and the core material, and disposed to project from the face plate toward the core material side. The crack arrester has flat side surfaces being in contact with the core material and extending along the thickness direction from a boundary surface between the face plate and the crack arrester. An angle formed by the side surface and the boundary surface is equal to or larger than 90 degrees.

A manufacturing method according to the present disclosure is for a sandwich panel for manufacturing a sandwich panel. The sandwich panel includes a core material having a plate shape; a pair of face plates respectively disposed on both sides in a thickness direction of the core material; and a crack arrester that is disposed on at least one side in the thickness direction of the core material, disposed between the face plate and the core material, and disposed to project from the face plate toward the core material side. The manufacturing method includes: forming a groove to have a shape complementary to the crack arrester on the core material; disposing a composite material to be the crack arrester in the groove; disposing the composite material to be the pair of face plates on both sides in the thickness direction of the core material; and joining the composite material with the core material to form the sandwich panel. The forming of the groove includes processing a working surface of the core material to form a groove having an opening and flat side surfaces extending along the thickness direction. An angle formed by the side surface and the working surface at the opening is equal to or larger than 90 degrees.

### Advantageous Effects of Invention

According to the present disclosure, delamination can be preferably suppressed even in a case in which external force with an impact is applied in a thickness direction.

### BRIEF DESCRIPTION OF DRAWINGS

FIG. 1 is a cross-sectional view of a sandwich panel according to a first embodiment.

FIG. 2 is an exploded perspective view illustrating constituent elements of the sandwich panel.

FIG. 3 is a flowchart related to a manufacturing method for the sandwich panel according to the first embodiment.

FIG. 4 is a diagram illustrating performance related to presence/absence of a crack arrester.

FIG. 5 is an explanatory diagram illustrating an analytic model of the crack arrester.

FIG. 6 is a diagram illustrating performance of an example corresponding to a type of the crack arrester.

FIG. 7 is a diagram illustrating performance of an example corresponding to a type of the crack arrester.

FIG. 8 is a diagram of a sandwich panel according to a second embodiment.

FIG. 9 is a cross-sectional view of a sandwich panel according to a third embodiment.

### DESCRIPTION OF EMBODIMENTS

The following describes embodiments according to the present disclosure in detail based on the drawings. Note that the present invention is not limited to the embodiments. Constituent elements in the following embodiments include a constituent element that is easily replaced by those skilled in the art, or substantially the same constituent element. The constituent elements described below can be appropriately combined with each other. In a case in which there are a plurality of embodiments, the embodiments can also be combined with each other.

### First Embodiment

### Sandwich Panel

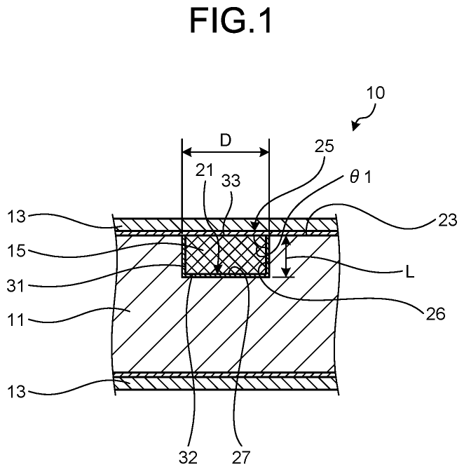

A sandwich panel 10 according to a first embodiment is a panel that is to be disposed on a vehicle, for example, an amphibious vehicle, to prevent a flying object from passing therethrough. FIG. 1 is a cross-sectional view of the sandwich panel according to the first embodiment. FIG.

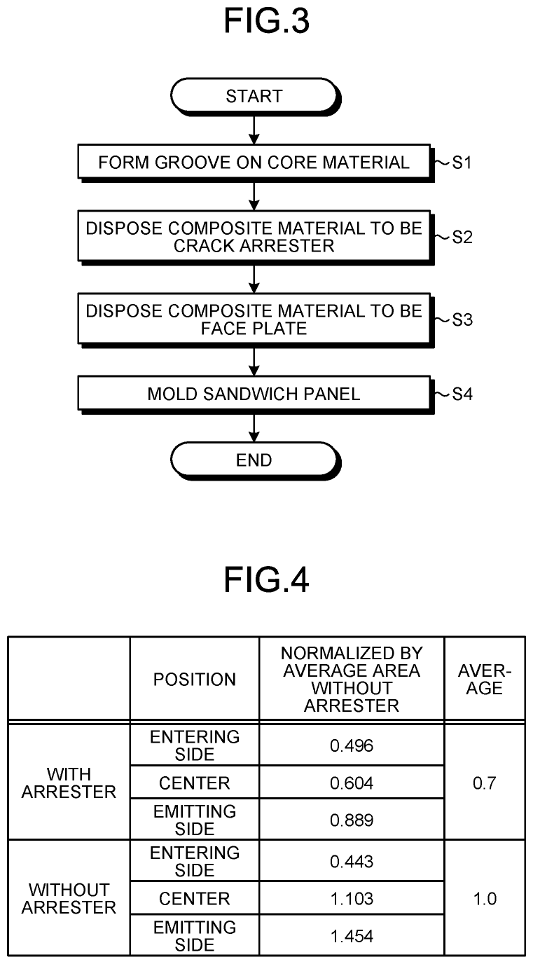

2 is an exploded perspective view illustrating constituent elements of the sandwich panel. FIG. 3 is a flowchart related to the manufacturing method for the sandwich panel according to the first embodiment.

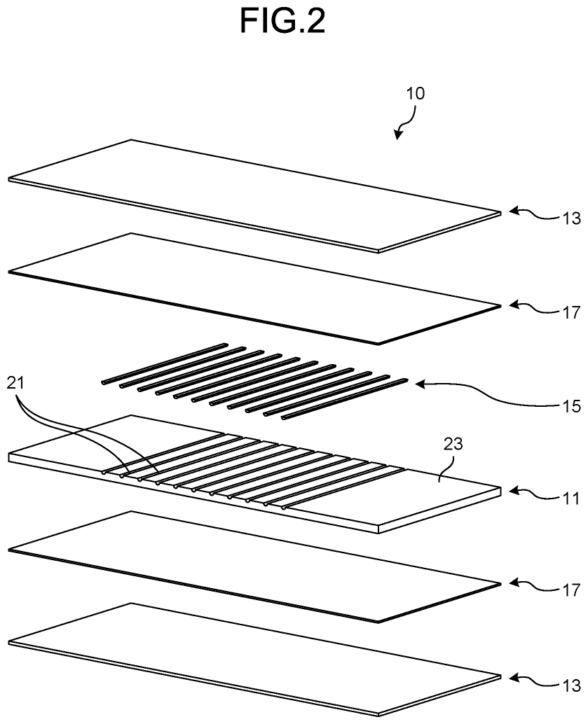

Flying object is assumed to move toward a thickness direction of the sandwich panel 10, so that a surface on one side of the sandwich panel 10 is an outer surface that the flying object enters, and a surface on the other side thereof is an inner surface from which the flying object is emitted. In FIG. 1 and FIG. 2, a lower side is an outer side, and an upper side is an inner side. Thus, the flying object moves from the lower side toward the upper side in FIG. 1 and FIG. 2.

As illustrated in FIG. 1 and FIG. 2, the sandwich panel 10 includes a core material 11, a pair of face plates 13, and crack arresters 15. As illustrated in FIG. 2, the sandwich panel 10 also includes a pair of adhesive films 17 respectively disposed between the core material 11 and the pair of face plates 13 at the time of molding.

The core material 11 is formed in a plate shape. The core material 11 is made of material having high rigidity, and has a shear modulus equal to or more than 50 MPa. The shear modulus of the core material 11 is more preferably in a range from not less than 136 MPa to not more than 362 MPa. As the core material 11, for example, a balsa core is applied. The balsa core is made by wood with porous material. In the first embodiment, the balsa core is applied as the core material 11, but the embodiment is not limited thereto. The core material 11 may be made of, for example, a resin-based foam material so long as such a material has high rigidity and achieves a shear modulus equal to or more than 50 MPa.

The core material 11 includes grooves 21 in which the crack arresters 15 are housed, the grooves 21 having a shape complementary to the crack arresters 15. The grooves 21 are formed by performing cutting work on one surface of the core material 11 as a working surface 23. The grooves 21 are formed to extend in one direction (longitudinal direction) within the working surface. As illustrated in FIG. 2, the grooves 21 are formed in parallel at predetermined intervals in the other direction (width direction) orthogonal to the one direction within the working surface. Each of the grooves 21 includes an opening 25, a pair of side surfaces 26, and a bottom surface 27, and a cross section of the groove 21 cut along a surface orthogonal to the longitudinal direction has a substantially quadrangular shape. The opening 25 is a part where the groove 21 opens, and disposed along the longitudinal direction. The pair of side surfaces 26 are surfaces opposed to each other in the width direction, and are flat surfaces extending along the thickness direction from the working surface 23. The bottom surface 27 is disposed across the pair of side surfaces 26. Thus, an inner surface side in the thickness direction of the side surface 26 intersects with the working surface 23, and an outer surface side in the thickness direction thereof intersects with the bottom surface 27.

In the first embodiment, the cross section of the groove 21 has a substantially quadrangular shape, but the shape is not particularly limited thereto. Details will be described later, but for example, the cross section thereof may have a shape illustrated in FIG. 9 as a third embodiment.

Each of the pair of face plates 13 is formed in a plate shape by using a composite material in which reinforced fiber is impregnated with resin. As the composite material, for example, a composite material such as carbon fiber reinforced plastics (CFRP) is used. The composite material is not limited to the CFRP, but may be any composite material containing reinforced fiber and resin. The pair of face plates 13 are joined to both surfaces of the core material 11 using an adhesive agent.

The crack arrester 15 is formed in a stick shape that is long in the longitudinal direction using a composite material in which reinforced fiber is impregnated with resin. Similarly to the face plate 13, a composite material such as the CFRP is used as the composite material. The composite material is not limited to the CFRP, but may be any composite material containing reinforced fiber and resin.

The crack arrester 15 is disposed on at least one side (inner side) in the thickness direction of the core material 11. Specifically, the crack arrester 15 is disposed between the core material 11 and the face plate 13 on one side (inner side) to project toward the core material 11 side from the face plate 13. The crack arrester 15 is housed in the groove 21 formed on the core material 11. The crack arrester 15 has a shape complementary to the groove 21. The crack arrester 15 is formed to extend in one direction (longitudinal direction) within the working surface. Additionally, as illustrated in FIG. 2, a plurality of the crack arresters 15 are formed to be arranged in parallel at predetermined intervals in the width direction within the working surface 23.

The crack arrester 15 has a pair of side surfaces 31 and a front end surface 32, and a cross section of the crack arrester 15 cut along a surface orthogonal to the longitudinal direction has a substantially quadrangular shape similarly to the groove 21. The crack arrester 15 also has a boundary surface 33 as a surface joined to the core material 11. The boundary surface 33 is positioned at the opening 25 of the groove 21, and formed along the longitudinal direction. The pair of side surfaces 31 are surfaces opposed to each other in the width direction, and are flat surfaces being in contact with the core material 11 and extending along the thickness direction from the boundary surface 33. The front end surface 32 is disposed across the pair of side surfaces 31. Thus, an inner surface side in the thickness direction of the side surface 31 intersects with the boundary surface 33 of the core material 11, and an outer surface side in the thickness direction thereof intersects with the front end surface 32.

An angle θ1 formed by the side surface 31 and the boundary surface 33 of the crack arrester 15 is equal to or larger than 90 degrees. Specifically, in the first embodiment, the angle θ1 is 90 degrees. That is, the pair of side surfaces 26 of the groove 21 and the pair of side surfaces 31 of the crack arrester 15 are in a state of being in vertical contact with the boundary surface 33. The angle θ1 is assumed to be 90 degrees in the first embodiment, but is not particularly limited thereto so long as the angle θ1 is equal to or larger than 90 degrees and smaller than 180 degrees. If the angle θ1 is equal to or larger than 90 degrees, load transfer due to shear or mechanical fitting between the crack arrester 15 and the core material 11 can be expected, and improvement in an effect of suppressing delamination can be expected.

Herein, a length in the width direction of the crack arrester 15 is assumed to be D, a length in the thickness direction thereof is assumed to be L, and a ratio of the length L in the thickness direction to the length D in the width direction on the boundary surface 33 is assumed to be L/D. In this case, the ratio L/D of the crack arrester is larger than ½. That is, the length L in the thickness direction is longer than a half of the length D in the width direction.

The adhesive films 17 are respectively disposed between the core material 11 and the pair of face plates 13 before molding of the sandwich panel 10. The adhesive film 17 is a thermosetting resin, for example, and is thermally cured after viscosity thereof is lowered when being heated at the time of molding, thereby joining the core material 11 with the face plate 13. Additionally, part of the adhesive films 17 is respectively disposed between the face plate 13 and the crack arresters 15, and is thermally cured after viscosity thereof is lowered when being heated at the time of molding, thereby joining the face plate 13 with the crack arresters 15.

Regarding the sandwich panel 10 as described above, when a flying object comes flying toward the sandwich panel 10, external force with an impact of the flying object is applied from an outer side toward an inner side in the thickness direction of the sandwich panel 10. That is, shearing force in the thickness direction is applied to the sandwich panel 10 due to the external force with the impact of the flying object. At this point, the side surface 26 of the core material 11 and the side surface 31 of the crack arrester 15 are joined to each other along the thickness direction, so that a structure having resistance against the shearing force is achieved, and occurrence and a developing range of delamination are suppressed.

### Manufacturing Method for Sandwich Panel

Next, the following describes the manufacturing method for the sandwich panel 10 with reference to FIG. 2 and FIG. 3. In the manufacturing method for the sandwich panel 10, described is a case of manufacturing the sandwich panel 10 illustrated in FIG. 1 and FIG. 2.

First, in the manufacturing method for the sandwich panel 10, the grooves 21 are formed on the core material 11 (Step S1). At Step S1, for example, the grooves 21 are formed by performing cutting work on the working surface 23 of the core material 11 using a machining device for performing cutting work. At Step S1, the grooves 21 are formed to extend in the longitudinal direction, and formed to be arranged in parallel at predetermined intervals in the width direction. As described above, the grooves 21 formed at Step S1 each have the opening 25, the pair of side surfaces 26, and the bottom surface 27. At this point, at Step S1, each of the grooves 21 is formed so that an angle formed by the side surface 26 and the working surface 23 of the core material 11 at the opening 25 is equal to or larger than 90 degrees.

Subsequently, in the manufacturing method for the sandwich panel 10, composite materials to be the crack arresters 15 are disposed in the grooves 21 (Step S2). As the composite material, used is a composite material before curing in which reinforced fiber is impregnated with resin, specifically, used is a unidirectional material to be continuous fiber extending in one direction. At Step S2, the composite material is disposed so that the longitudinal direction of the groove 21 becomes a fiber direction.

Next, in the manufacturing method for the sandwich panel 10, composite materials to be the pair of face plates 13 are disposed on both sides in the thickness direction of the core material 11 (Step S3). As the composite material, used is a composite material before curing in which reinforced fiber is impregnated with resin, specifically, used is a fiber sheet. At Step S3, at the time of disposing the pair of face plates 13, the adhesive films 17 are respectively disposed between the core material 11 and the face plates 13.

In the manufacturing method for the sandwich panel 10, the composite materials and the adhesive films 17 are heated and thermally cured to mold the pair of face plates 13 and the crack arresters 15, and the pair of face plates 13 and the core material 11 are joined to each other to form the sandwich panel 10 (Step S4).

### Performance of Sandwich Panel

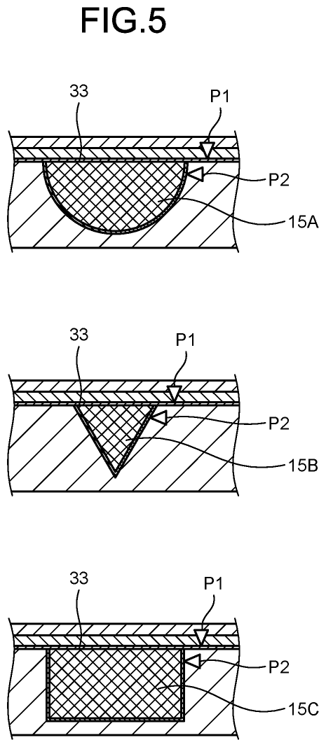

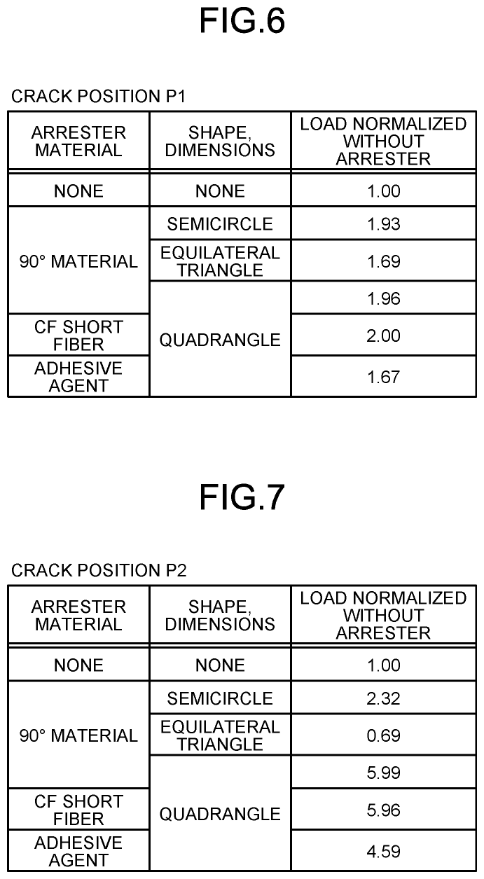

Next, the following describes performance of the sandwich panel 10 with reference to FIG. 4 to FIG. 7. FIG. 4 is a diagram illustrating performance related to presence/absence of the crack arrester. FIG. 5 is an explanatory diagram illustrating an analytic model of the crack arrester. FIG. 6 and FIG. 7 are diagrams illustrating performance of examples corresponding to types of the crack arrester.

With reference to FIG. 4, damaged areas on the sandwich panel with crack arresters 15 and the sandwich panel without crack arresters 15 generated by collision with a flying object are compared with each other. As illustrated in FIG. 4, the damaged area has a numerical value normalized by an average damaged area in a case in which the crack arresters 15 are absent. In a case in which the crack arresters 15 are present, the damaged area is increased from an entering side toward an emitting side from the flying object. On the other hand, an average damaged area in a case in which the crack arresters 15 are present is smaller than an average damaged area in a case in which the crack arresters 15 are absent.

Next, with reference to FIG. 5, the following describes an analytic model for evaluating the crack arresters 15 of different types. A conventional crack arrester 15A illustrated on an upper side of FIG. 5 has a semicircular cross section cut along a surface orthogonal to the longitudinal direction. A conventional crack arrester 15B illustrated in the middle of FIG. 5 has an equilateral triangular cross section cut along a surface orthogonal to the longitudinal direction, a base of the cross section being the boundary surface 33. A crack arrester 15C according to the present embodiment illustrated on a lower side of FIG. 5 has a quadrangular cross section cut along a surface orthogonal to the longitudinal direction, and the ratio L/D is ½.

A position P1 and a position P2 in FIG. 5 are positions for evaluating delamination. The position P1 is a predetermined position outside the crack arresters 15A, 15B, and 15C on the boundary surface 33. The position P2 is a position at a predetermined depth in the thickness direction from the boundary surface 33.

In FIG. 6, loads with which delamination develops at the position P1 are compared with each other depending on shapes of the crack arresters 15A, 15B, and 15C illustrated in FIG. 5. That is, evaluation is made for a load with respect to a lateral mode in which delamination triggered when external force is applied in an in-plane direction of the boundary surface 33 by the flying object develops in a lateral direction. As illustrated in FIG. 6, each load has a numerical value normalized by a load in a case in which the crack arresters 15 are absent. As materials of the crack arresters 15A, 15B, and 15C, used are a composite material obtained by overlapping unidirectional materials while causing fiber directions thereof to be different by 90°, a composite material containing carbon fiber being short fiber, and a resin material obtained by curing an adhesive agent.

As illustrated in FIG. 6, the crack arrester 15C having a quadrangular shape and made of a composite material containing reinforced fiber may be more load-bearing, and particularly, the crack arrester 15C made of carbon fiber being short fiber may be the most load-bearing. Although having a quadrangular shape, the crack arrester 15C made of a resin material has a load smaller than that of the crack arrester made of a composite material. The crack arrester 15A having a semicircular shape and the crack arrester 15B having an equilateral triangular shape each have a load smaller than that of the crack arrester having a quadrangular shape and made of a composite material. Thus, it has been confirmed by analysis that delamination hardly develops at the position P1 in the crack arrester 15C having a quadrangular shape and made of the composite material as compared with the other crack arresters 15A and 15B.

In FIG. 7, loads with which delamination develops at the position P2 are compared with each other depending on the shapes of the crack arresters 15A, 15B, and 15C illustrated in FIG. 5. That is, evaluation is made for a load with respect to a vertical mode in which delamination triggered when external force is applied in the thickness direction of the sandwich panel 10 by the flying object develops in a plate thickness direction. In FIG. 7, similarly to FIG. 6, the load has a numerical value normalized by a load in a case in which the crack arresters 15 are absent. The materials of the crack arresters 15A, 15B, and 15C in FIG. 7 are the same as those in FIG. 6.

As illustrated in FIG. 7, the crack arrester 15C having a quadrangular shape and made of a composite material containing reinforced fiber may be more load-bearing, and particularly, the crack arrester 15C obtained by overlapping unidirectional materials while causing directions thereof to be different by 90° may be the most load-bearing. Although having a quadrangular shape, the crack arrester 15C made of a resin material has a load smaller than that of the crack arrester made of a composite material. The crack arrester 15A having a semicircular shape and the crack arrester 15B having an equilateral triangular shape each have a load smaller than that of the crack arrester having a quadrangular shape and made of a composite material. Thus, it has been confirmed by analysis that delamination hardly develops at the position P2 in the crack arrester 15C having a quadrangular shape and made of a composite material as compared with the other crack arresters 15A and 15B.

### Second Embodiment

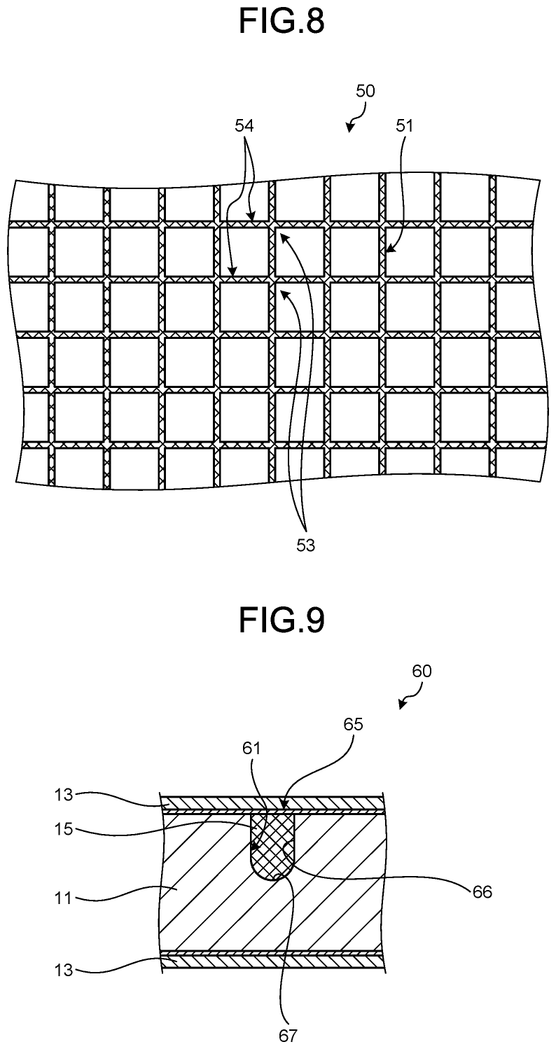

Next, the following describes a second embodiment with reference to FIG. 8. In the second embodiment, portions different from those in the first embodiment are described to avoid redundant description. A portion having the same configuration as that in the first embodiment will be denoted by the same reference numeral. FIG. 8 is a diagram of the sandwich panel according to the second embodiment.

A sandwich panel 50 in the second embodiment includes a crack arrester 51 in place of the crack arresters 15 in the first embodiment. The crack arrester 51 in the second embodiment is formed in a lattice shape having intersecting portions 53 and side portions 54 within the boundary surface 33. Due to this, on the core material 11 of the sandwich panel 50, a lattice-shaped groove having a shape complementary to the crack arrester 51 is formed in place of the grooves 21 in the first embodiment.

In the crack arrester 51 having the lattice shape, the side portions 54 extend in the longitudinal direction and also extend in the width direction. The side portions 54 extending in the longitudinal direction are disposed in parallel in the width direction. The side portions 54 extending in the width direction are disposed in parallel in the longitudinal direction. A part where the side portion 54 extending in the longitudinal direction intersects with the side portion 54 extending in the width direction is the intersecting portion 53.

The intersecting portion 53 includes, as reinforced fiber contained in a composite material, reinforced fiber being short fiber. That is, the composite material used for the intersecting portion 53 is a short-fiber reinforced resin. The side portion 54 is continuous fiber as reinforced fiber contained in a composite material in which a fiber direction of the reinforced fiber extends in a direction along the side. That is, the composite material used for the side portion 54 is a fiber-reinforced resin using a unidirectional material. Due to this, in the crack arrester 51, the composite materials at the intersecting portion 53 are prevented from overlapping in the thickness direction of the reinforced fiber, so that the thickness of the intersecting portion 53 is enabled to be equivalent to that of the side portion 54.

A cross section of the side portion 54 of the crack arrester 51 cut along a surface orthogonal to a direction along the side is the same as the cross section in the first embodiment. In the crack arrester 51 according to the second embodiment, the unidirectional material is used as the reinforced fiber for the side portion 54, but the reinforced fiber for the side portion 54 may be short fiber similarly to the reinforced fiber for the intersecting portion 53. That is, all reinforced fiber in the composite material may be short fiber.

### Third Embodiment

Next, the following describes a third embodiment with reference to FIG. 9. In the third embodiment, portions different from those in the first and the second embodiments are described to avoid redundant description. A portion having the same configuration as that in the first and the second embodiments will be denoted by the same reference numeral. FIG. 9 is a cross-sectional view of the sandwich panel according to the third embodiment.

In a sandwich panel 60 according to the third embodiment, a groove 61 formed on the core material 11 has a shape different from that of the groove 21 in the first embodiment. The groove 61 in the third embodiment is a groove on which cutting work is performed with an end mill having a rounded front end. The groove 61 has an opening 65, a pair of side surfaces 66, and a bottom surface 67. The opening 65 is a part where the groove 61 opens, and disposed along the longitudinal direction similarly to the opening 25 in the first embodiment. The pair of side surfaces 66 are surfaces opposed to each other in the width direction, and are flat surfaces extending along the thickness direction from the working surface 23 similarly to the side surfaces 26 in the first embodiment. The bottom surface 67 is disposed across the pair of side surfaces 66, and has a shape along the front end of the end mill. Specifically, the bottom surface 67 is a curved surface projecting downward with a predetermined curvature at a cross section cut along the longitudinal direction. Due to this, the front end surface 32 of the crack arrester 15 having a shape complementary to the groove 61 is also a curved surface with the predetermined curvature. The front end surface 32 of the crack arrester 15 is a surface continuous to the core material 11 side in the thickness direction of the side surface 31.

In the manufacturing method for the sandwich panel 10, in a case of forming the groove 61 according to the third embodiment, the groove 61 is formed by performing cutting work on the working surface 23 of the core material 11 using the end mill at Step S1. Specifically, at Step S1, the end mill is caused to abut on the working surface 23 of the core material 11 to perform cutting work while being rotated, and the end mill is moved relatively to the core material 11 along the longitudinal direction of the groove 61. Due to this, in the third embodiment, the groove 61 that is long in the longitudinal direction illustrated in FIG. 9 is formed by the end mill.

The shapes of the crack arresters 15 and 51 described in the first embodiment to the third embodiment are not particularly limited, but the crack arrester 15 may have any shape so long as the angle formed by the side surface and the boundary surface 33 is equal to or larger than 90 degrees. For example, the crack arrester 15 may be a dovetail projection the side surfaces 31 of which spread out toward the front end side in the thickness direction.

As described above, the sandwich panels 10, 50, and 60, and the manufacturing method for the sandwich panels 10, 50, and 60 described in the present embodiments are grasped as follows, for example.

The sandwich panels 10, 50, and 60 according to a first aspect include: the core material 11 having a plate shape; the pair of face plates 13 that are formed using the composite material and respectively disposed on both sides in the thickness direction of the core material 11; and the crack arresters 15 and 51 that are formed using the composite material, disposed on at least one side in the thickness direction of the core material 11, disposed between the face plate 13 and the core material 11, and disposed to project from the face plate 13 toward the core material 11 side. The crack arresters 15 and 51 include the flat side surfaces 31 being in contact with the core material 11 and extending along the thickness direction from the boundary surface 33 between the face plate 13 and the crack arresters 15 and 51. The angle formed by the side surface 31 and the boundary surface 33 is equal to or larger than 90 degrees.

With this configuration, even in a case of a load (shearing force) in the vertical mode in which external force with an impact is applied in the thickness direction, a structure having resistance against occurrence and development of delamination due to the shearing force can be achieved. Due to this, delamination between the crack arresters 15 and 51 and the core material 11 at a joint part can be preferably suppressed.

As a second aspect, the crack arresters 15 and 51 include the two side surfaces 31 opposed to each other in the in-plane direction of the boundary surface 33. Assuming that the direction in which the side surfaces 31 are opposed to each other is the width direction, the length in the width direction of the crack arresters 15 and 51 is D, and the ratio of the length L in the thickness direction to the length D in the width direction on the boundary surface 33 is L/D, the ratio of the crack arresters 15 and 51 is larger than ½.

With this configuration, the length L in the thickness direction of the crack arresters 15 and 51 can be increased, so that the resistance against the shearing force can be further increased.

As a third aspect, the crack arresters 15 and 51 include the two side surfaces 31 opposed to each other in the in-plane direction of the boundary surface 33, and the front end surface 32 to be a surface connected to the core material 11 side in the thickness direction of the side surface 31.

With this configuration, the crack arrester 15 having a simple shape can be formed by the two side surfaces 31 and the front end surface 32. The shape of the front end surface is not particularly limited, and may be a flat surface, or a curved surface with a predetermined curvature.

As a fourth aspect, the crack arresters 15 are disposed to extend in the longitudinal direction as a predetermined direction within the boundary surface 33, and disposed in parallel at predetermined intervals in the direction orthogonal to the longitudinal direction. The crack arrester 15 includes, as reinforced fiber contained in the composite material, a unidirectional material in which the fiber direction of the reinforced fiber is the longitudinal direction.

With this configuration, the composite material can be disposed so that the fiber direction thereof becomes the longitudinal direction of the crack arresters 15, so that the crack arresters 15 can be molded to be strong against external force.

As a fifth aspect, the crack arrester 15 is formed in a lattice shape having the intersecting portions 53 and the side portions 54 within the boundary surface 33. The intersecting portion 53 includes the reinforced fiber being short fiber as reinforced fiber contained in the composite material, and the side portion 54 includes the unidirectional material in which the fiber direction of the reinforced fiber is a direction along the side as the reinforced fiber contained in the composite material.

With this configuration, it is possible to prevent the thickness of the intersecting portion 53 from being increased due to overlap of fibers at the intersecting portion 53. Due to this, the entire thickness of the crack arrester 15 can be made uniform.

As a sixth aspect, the core material 11 includes the groove 61 formed to have a shape complementary to the crack arrester 15, and the groove 61 is a groove processed by using the end mill.

With this configuration, the groove 61 can be easily formed by the end mill.

As a seventh aspect, the core material 11 has a shear modulus equal to or more than 50 MPa.

With this configuration, even in a case in which the flying object collides with the sandwich panels 10, 50, and 60, a range of damage of the sandwich panels 10, 50, and 60 caused by the flying object can be suppressed.

As an eighth aspect, the core material 11 is the balsa core.

With this configuration, the core material 11 that can suppress the range of damage caused by the flying object can be obtained by using an inexpensive material.

The manufacturing method for the sandwich panels 10, 50, and 60 according to a ninth aspect is the manufacturing method for the sandwich panels 10, 50, and 60 for manufacturing the sandwich panels 10, 50, and 60 including: the core material 11 having a plate shape; the pair of face plates 13 respectively disposed on both sides in the thickness direction of the core material 11; and the crack arresters 15 and 51 that are disposed on at least one side in the thickness direction of the core material 11, disposed between the face plate 13 and the core material 11, and disposed to project from the face plate 13 toward the core material 11 side. The manufacturing method includes: Step S1 for forming the grooves 21 and 61 to have a shape complementary to the crack arrester 15 on the core material 11; Step S2 for disposing the composite material to be the crack arrester 15 on the grooves 21 and 61; Step S3 for disposing the composite materials to be the pair of face plates 13 on both sides in the thickness direction of the core material 11; and Step S4 for joining the composite material with the core material 11 to form the sandwich panels 10, 50, and 60. At Step S1 for forming the grooves 21 and 61, the grooves 21 and 61 each having the opening 25 and the flat side surfaces 26 extending along the thickness direction are formed by processing the working surface of the core material 11, and the angle formed by the side surface 26 and the working surface at the opening 25 is equal to or larger than 90 degrees.

With this configuration, the side surfaces 31 of the crack arresters 15 and 51 having a shape complementary to the grooves 21 and 61 can be formed so that the angle formed by the side surface 31 and the boundary surface 33 is equal to or larger than 90 degrees. Due to this, even in a case of a load (shearing force) in the vertical mode in which external force is applied in the thickness direction, a structure having resistance against the shearing force can be achieved. Accordingly, delamination between the crack arresters 15 and 51 and the core material 11 at the joint part can be preferably suppressed.

### REFERENCE SIGNS LIST

10 Sandwich panel

11 Core material

13 Face plate

15 Crack arrester

17 Adhesive film

21 Groove

23 Working surface

25 Opening

26 Side surface

27 Bottom surface

31 Side surface

32 Front end surface

33 Boundary surface

50 Sandwich panel (second embodiment)

51 Crack arrester (second embodiment)

53 Intersecting portion

54 Side portion

60 Sandwich panel (third embodiment)

61 Groove (third embodiment)

65 Opening (third embodiment)

66 Side surface (third embodiment)

67 Bottom surface (third embodiment)

1. A sandwich panel comprising:
a core material having a plate shape;
a pair of face plates that are formed using a composite material, and respectively disposed on both sides in a thickness direction of the core material; and
a crack arrester that is formed using the composite material, disposed on at least one side in the thickness direction of the core material, disposed between the face plate and the core material, and disposed to project from the face plate toward the core material side, wherein
the crack arrester has flat side surfaces being in contact with the core material and extending along the thickness direction from a boundary surface between the face plate and the crack arrester, and
an angle formed by the side surface and the boundary surface is equal to or larger than 90 degrees.

2. The sandwich panel according to claim 1, wherein
the crack arrester includes the two side surfaces opposed to each other in an in-plane direction of the boundary surface, and,
a ratio of the crack arrester L/D is larger than ½, where a direction in which the side surfaces are opposed to each other is a width direction, D is a length in the width direction of the crack arrester, and L is a length in the thickness direction to the length D in the width direction on the boundary surface.

3. The sandwich panel according to claim 1, wherein the crack arrester includes
the two side surfaces opposed to each other in an in-plane direction of the boundary surface, and
a front end surface as a surface connected to the core material side in the thickness direction of the side surface.

4. The sandwich panel according to claim 1, wherein a plurality of the crack arresters are disposed to extend in a longitudinal direction as a predetermined direction within the boundary surface, disposed in parallel at predetermined intervals in a direction orthogonal to the longitudinal direction, and include, as reinforced fiber contained in the composite material, a unidirectional material in which a fiber direction of the reinforced fiber is the longitudinal direction.

5. The sandwich panel according to claim 1, wherein
the crack arrester is formed in a lattice shape having intersecting portions and side portions within the boundary surface,
the intersecting portion includes the reinforced fiber being short fiber as reinforced fiber contained in the composite material, and
the side portion includes, as reinforced fiber contained in the composite material, a unidirectional material in which a fiber direction of the reinforced fiber is a direction along a side.

6. The sandwich panel according to claim 1, wherein
the core material includes a groove formed to have a shape complementary to the crack arrester, and
the groove is a groove processed by using an end mill.

7. The sandwich panel according to claim 1, wherein the core material has a shear modulus equal to or more than 50 MPa.

8. The sandwich panel according to claim 7, wherein the core material is a balsa core.

9. A manufacturing method for a sandwich panel for manufacturing a sandwich panel including:
a core material having a plate shape;
a pair of face plates respectively disposed on both sides in a thickness direction of the core material; and
a crack arrester that is disposed on at least one side in the thickness direction of the core material, disposed between the face plate and the core material, and disposed to project from the face plate toward the core material side,
the manufacturing method comprising:
forming a groove to have a shape complementary to the crack arrester on the core material;
disposing a composite material to be the crack arrester in the groove;
disposing the composite material to be the pair of face plates on both sides in the thickness direction of the core material; and
joining the composite material with the core material to form the sandwich panel, wherein
the forming of the groove includes processing a working surface of the core material to form a groove having an opening and flat side surfaces extending along the thickness direction, and
an angle formed by the side surface and the working surface at the opening is equal to or larger than 90 degrees.
